(19) United States
(12) Patent Application Publication
(10) Pub. No.: US 2023/0081543 A1
(43) Pub. Date: Mar. 16, 2023

(54) METHOD FOR SYNTHETIZING SPEECH AND ELECTRONIC DEVICE

(71) Applicant: BEIJING BAIDU NETCOM SCIENCE TECHNOLOGY CO., LTD., Beijing (CN)

(72) Inventors: Bo Peng, Beijing (CN); Yongguo Kang, Beijing (CN); Cong Gao, Beijing (CN)

(73) Assignee: BEIJING BAIDU NETCOM SCIENCE TECHNOLOGY CO., LTD., Beijing (CN)

(21) Appl. No.: 18/057,363

(22) Filed: Nov. 21, 2022

(30) Foreign Application Priority Data
Dec. 17, 2021 (CN) 202111558284.2

(51) Int. Cl. G10L 13/08; G10L 15/26; G10L 15/22; G10L 21/0232; G10L 25/18; G10L 13/047; G10L 15/02

(52) U.S. Cl. CPC G10L 13/08; G10L 15/26; G10L 15/22; G10L 21/0232; G10L 25/18; G10L 13/047; G10L 15/02

(57) ABSTRACT

A method for synthetizing a speech includes: obtaining a source speech; suppressing a noise in the source speech based on an amplitude component and/or phase component of the source speech, to obtain a noise-reduced speech; performing a speech recognition process on the noise-reduced speech to obtain corresponding text information; inputting the text information of the noise-reduced speech and a preset tag into a trained acoustic model to obtain a predicted acoustic feature matching the text information; and generating a target speech based on the predicted acoustic feature.

### CROSS-REFERENCE TO RELATED APPLICATIONS

This application is based upon and claims priority to Chinese Patent Application No. 202111558284.2, filed on Dec. 17, 2021, the entire content of which is incorporated herein by reference.

### FIELD

The present disclosure relates to the field of Artificial Intelligence (AI) technology, in particular to the fields of deep learning and speech technology, and provides a method for synthetizing a speech, an apparatus for synthetizing a speech, an electronic device and a storage medium.

### BACKGROUND

With the development of Internet technology, many industries have begun to use virtual digital human to interact with users by speech, such as media and customer service. The virtual digital human needs to be able to speak naturally and fluently during the work process, to be able to flexibly respond to questions asked, and to be as verbally expressive as possible as a real person.

Therefore, how to improve the accuracy of speech synthesis of virtual digital human is a technical problem that needs to be solved.

### SUMMARY

According to a first aspect of the present disclosure, a method for synthetizing a speech is provided. The method includes: obtaining a source speech; suppressing a noise in the source speech based on an amplitude component and/or phase component of the source speech, to obtain a noise-reduced speech; performing a speech recognition process on the noise-reduced speech, to obtain corresponding text information; inputting the text information of the noise-reduced speech and a preset tag into a trained acoustic model to obtain a predicted acoustic feature matching the text information; and generating a target speech based on the predicted acoustic feature.

According to a second aspect of the present disclosure, an electronic device is provided. The electronic device includes: at least one processor and a memory communicated with the at least one processor. The memory stores instructions executable by the at least one processor, and when the instructions are executed by the at least one processor, the at least one processor is configured to implement the method according to the first aspect of the present disclosure.

According to the third aspect of the present disclosure, a non-transitory computer-readable storage medium having stored computer instructions is provided. The computer instructions are executed to cause a computer to implement the method according to the first aspect of the present disclosure.

### BRIEF DESCRIPTION OF THE DRAWINGS

The drawings are used to better understand the solution and do not constitute a limitation to the present disclosure, in which:

FIG. 1 is a flowchart of a method for synthetizing a speech according to some embodiments of the present disclosure.

FIG. 2 is a flowchart of a method for synthetizing a speech according to some embodiments of the present disclosure.

FIG. 3 is a flowchart of a process for determining an amplitude suppression factor of at least one subband according to some embodiments of the present disclosure.

FIG. 4 is a flowchart of a process for determining a phase correction factor of at least one subband according to some embodiments of the present disclosure.

FIG. 5 is a block diagram of a noise reduction process according to some embodiments of the present disclosure.

FIG. 6 is a block diagram of an apparatus for synthetizing a speech according to some embodiments of the present disclosure.

FIG. 7 is a block diagram of an electronic device 700 according to some embodiments of the present disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

It is noted that the terms “first” and “second” in the specification and claims of the present disclosure and the accompanying drawings are used to distinguish similar objects and need not be used to describe a particular order or sequence. It should be understood that the data may be interchanged when appropriate, so that the embodiments of the present disclosure described herein can be implemented in an order other than those illustrated or described herein.

It should be noted that acquisition, storage and application of personal information of users involved in the technical solution of the present disclosure are in compliance with relevant laws and regulations and do not violate public order and morality.

The embodiment of the present disclosure provides a method for synthetizing a speech, to solve the problems of poor accuracy and poor effect of speech synthesis of virtual digital human due to the influence of environmental noise in the related art.

A method for synthetizing a speech, an apparatus for synthetizing a speech, an electronic device, a non-transitory computer-readable storage medium and a computer program product of the embodiments of the present disclosure are described below with reference to the accompanying drawings.

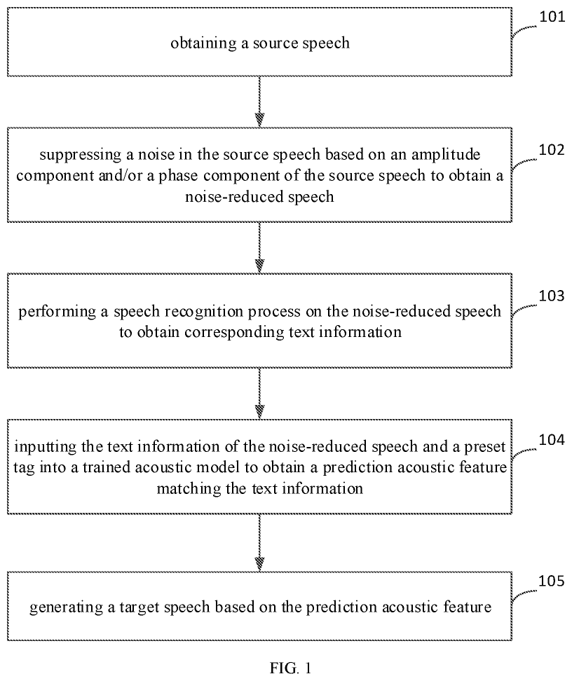

The method for synthetizing a speech provided by the present disclosure is first described in detail in combination with FIG. 1.

FIG. 1 is a flowchart of a method for synthetizing a speech of the present disclosure.

The embodiments of the present disclosure provide a method for synthetizing a speech, and the execution body is an apparatus for synthetizing a speech. The apparatus for synthetizing a speech may be an electronic device or may be configured in an electronic device to implement a noise suppression process on a source speech based on an amplitude component and/or a phase component of the source speech, and to generate a target speech based on a predicted acoustic feature. The embodiments of the present disclosure are illustrated by an apparatus for synthetizing a speech being configured in the electronic device.

The electronic device may be any stationary or mobile computing device capable of data processing, such as a mobile computing device (e.g., a laptop, a smartphone, and a wearable device), or a stationary computing device (e.g., a desktop computer), a server, and other types of computing device.

As shown in FIG. 1, the method for synthetizing a speech includes the following operations.

At block 101, a source speech is obtained.

The source speech can be a speech uttered by any speaker.

It should be noted that the apparatus for synthetizing a speech in the embodiment may obtain the information of the source speech in various open, legal and compliant ways. For example, the apparatus for synthetizing a speech may, after being authorized by the speaker, collect the speech information of the speaker in real time while the speaker is speaking, the audio information of the speaker from other devices after being authorized by the speaker, or the source speech information obtained in various open, legal and compliant ways.

Taking a customer service scene as an example where a real customer service is used to drive the virtual digital human, the speech information of the real customer service is the source speech. After the real customer service is authorized, the apparatus for synthetizing a speech can collect speech of the real customer service in real time when the real customer service is speaking, so that the source speech information can be obtained.

At block 102, a noise in the source speech is suppressed based on an amplitude component and/or a phase component of the source speech to obtain a noise-reduced speech.

In the daily acoustic environment, speech is usually disturbed by reverberation and background noises, thus noise reduction is required. In an embodiment, the noise-reduced speech is obtained by performing the noise reduction process on the source speech according to the amplitude component of the source speech. Alternatively, the noise-reduced speech is obtained by performing the noise reduction process on the source speech according to the phase component of the source speech. Alternatively, the noise-reduced speech is obtained by performing the noise reduction process on the source speech according to the amplitude component and the phase component of the source speech.

The noise-reduced speech is speech after suppressing the noise in the source speech, and can clearly represent speech information of the source speech.

In an embodiment, a subband decomposition process is performed on the source speech (i.e., the source speech is broken into subbands using a band pass filter), and features of the amplitude component and/or phase component of each subband is obtained. The noise-reduced speech is obtained by amplitude suppression process and/or phase correction process for the subbands. Similarly, the subband decomposition process is performed on the source speech, the feature of the amplitude component of each subband is extracted, the amplitude suppression process is performed on each subband accordingly, and the noise-reduced speech is obtained. Alternatively, the subband decomposition process is performed on the source speech, the feature of the phase component of each subband is extracted, the phase correction process is performed on each subband accordingly, and the noise-reduced speech is obtained. Alternatively, the subband decomposition process is performed on the source speech, the features of the phase component and the feature of the phase component of each subband are extracted, the amplitude suppression process and the phase correction process are performed on each subband accordingly, and the noise-reduced speech is obtained.

Since the noise(s) in the source speech can be suppressed according to the amplitude component and/or phase component of the source speech, the noise-reduced speech is obtained, which can effectively reduce the interference of ambient noises and improve the effectiveness of speech synthesis.

At block 103, a speech recognition process is performed on the noise-reduced speech to obtain corresponding text information.

The text information is text-related information in the noise-reduced speech, and the text information can represent a speech text content of the noise-reduced speech.

In an embodiment, a phonetic posteriorgram (PPG) feature is obtained by performing the speech recognition process on the noise-reduced speech, and the PPG feature can be used as the text information of the noise-reduced speech. A physical meaning of the PPG feature is a probability distribution of linguistic units to which each acoustic segment belongs, which can be used to represent a probability that at least one acoustic segment of the noise-reduced speech belongs to a preset linguistic unit. In another embodiment, the text information can be other features such as a phoneme sequence.

In an embodiment, a speech recognition model can be pre-trained. An input of the speech recognition model is the noise-reduced speech to be recognized, and an output of the model is the text information of the noise-reduced speech. In this way, the text information corresponding to the noise-reduced speech can be obtained by inputting the noise-reduced speech into the trained speech recognition model. The speech recognition model may be any model capable of recognizing text information, such as a neural network model.

At block 104, the text information of the noise-reduced speech and a preset tag are input into a trained acoustic model to obtain a predicted acoustic feature matching the text information.

In an embodiment, the acoustic model can be pre-trained, and the trained acoustic model can be used to convert the text information of the noise-reduced speech and the preset tag into the predicted acoustic feature(s) matching the text information.

The preset tag indicates a timbre feature of a target speech. That is, the preset tag includes a preset timbre feature, and the trained acoustic model is configured to convert a timbre feature of the source speech into the preset timbre feature. For example, taking a customer service scene as an example where a real customer service is used to drive the virtual digital human, assuming that an image of the virtual digital human is the same as speaker A, when driving the virtual digital human by speech of a real customer service B, a noise-reduced speech of the real customer service B needs to be converted into a speech whose corresponding timbre is the same as the timbre of the speaker A. In this case, the preset tag indicates that the timbre of the target speech should be consistent with the timbre of the speaker A. It should be noted that the image of the virtual digital human in the embodiments of the present disclosure is not an image specific to a particular user and does not reflect the personal information of the particular user.

The acoustic feature is a physical quantity that represents the speech acoustic feature. In an embodiment, the acoustic feature may be a spectral envelope feature of mel scale or other features such as a fundamental frequency feature.

In a possible implementation, the speaker of the source speech is considered as a source speaker, the speaker whose timbre matches a timbre indicated by the preset tag is considered as the target speaker. On this basis, the predicted acoustic feature matching the text information, i.e., an acoustic feature of the noise-reduced speech corresponding to the target speaker, represents the speech acoustic feature of the noise-reduced speech corresponding to the target speaker. The target speaker may be a preset specific speaker, for example, a speaker whose speech matches the image of the virtual digital human. Thus, the text information identified in the noise-reduced speech of the source speaker and the preset tag can be converted into the predicted acoustic feature matching the text information, and the predicted acoustic feature represents the speech acoustic feature of the noise-reduced speech from the source speaker corresponding to the target speaker.

At block 105, a target speech is generated based on the predicted acoustic feature.

In an embodiment, after obtaining the predicted acoustic feature matching the text information, the target speech can be generated based on the predicted acoustic feature. The timbre corresponding to the target speech is identical to the timber indicated by the preset tag, so that the noise-reduced speech is converted into the target speech whose timbre matches the timbre indicated by the preset tag.

It is appreciated that the target speech generated in the embodiments can be used to drive the virtual digital human, and since it is ensured that the target speech is consistent with the image of the virtual digital human by means of the preset tag (that is, the timbre of the target speech fits preset identity characteristics of the digital human), the method for synthetizing a speech of the present disclosure can be used to convert the source speech after the noise reduction process into the target speech with a corresponding timbre complying with the image of the virtual digital human, regardless of the speaker of the source speech. Therefore, with the present method, in responding to driving the virtual digital human with the target speech, the speech of the virtual digital human fits or is consistent with the image of the virtual digital human.

For example, in a customer service scenario where the virtual digital human is driven by speech of a real customer service, assuming that an image of the virtual digital human is consistent with the speech of the speaker A, since the method for synthetizing a speech of the present disclosure enables the conversion of the noise-reduced speech into the target speech whose timbre is consistent with the timbre indicated by the preset tag, the target speech that is consistent with the timbre of the speaker A can be obtained regardless of whether the source speech originates from speaker B or C or any other speaker, thus the speech of the virtual digital human can be guaranteed to be consistent with the image when the target speech is used to drive the virtual digital human.

It is noted that in the method for synthetizing a speech of the present disclosure, since the text information extracted from the source speech after the noise reduction process is directly converted into the predicted acoustic feature matching the text information, and the target speech is generated based on the predicted acoustic feature, the target speech remains the features such as the emotion, tone and other features of the source speech speaker, so that when the target speech generated by the present disclosure drives the virtual digital human, the speech of the virtual digital human can be enriched with mood, tone and other real-life features of the source speech speaker, thereby bringing a vivid interactive experience to the user and enhancing fun and freshness feelings of the user when communicating with the virtual digital human.

According to the method for synthetizing a speech of the present disclosure, the source speech is obtained, the noise in the source speech is suppressed according to the amplitude component and/or phase component of the source speech to obtain the noise-reduced speech. After performing the speech recognition process on the noise-reduced speech to obtain the corresponding text information, the text information of the noise-reduced speech and the preset tag are input into the trained acoustic model to obtain the predicted acoustic feature matching the text information. The target speech is generated based on the predicted acoustic feature. Therefore, by performing the noise reduction process on the source speech based on the amplitude component and/or phase component of the source speech, the noise interference is reduced. Moreover, by performing the speech recognition on the noise-reduced speech to obtain the text information of the noise-reduced speech (such as the PGG feature), the effectiveness of the speech synthesis is improved.

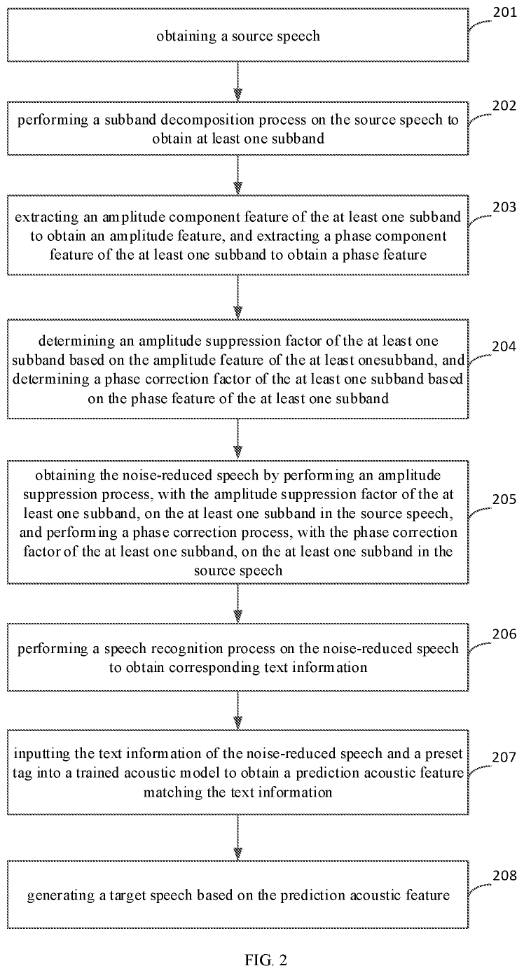

It can be seen from the above analysis that in this embodiment of the present disclosure, the noise-reduced speech can be obtained via the subband decomposition and the feature extraction, and the process of obtaining the noise-reduced speech via the subband decomposition and the feature extraction is further described below in combination with FIG. 2.

FIG. 2 is a flowchart of a method for synthetizing a speech of the present disclosure. As shown in FIG. 2, the method for synthetizing a speech includes the following operations.

At block 201, a source speech is obtained.

The specific implementation process and principle of block 201 can be described with reference to block 101 of the above embodiment and will not be repeated here.

At block 202, a subband decomposition process is performed on the source speech to obtain at least one subband.

In the embodiment of the present disclosure, the subband decomposition process is performed on the source speech to obtain at least one subband. The at least one subband includes a plurality of components, such as an amplitude component, and a phase component.

At block 203, an amplitude component feature of the at least one subband is extracted to obtain an amplitude feature, and a phase component feature of the at least one subband is extracted to obtain a phase feature.

In the embodiment of the present disclosure, the amplitude component feature of the at least one subband is extracted to obtain the amplitude feature, and the phase component feature of the at least one subband is extracted to obtain the phase feature.

In the embodiment of the present disclosure, a feature extraction model may be pre-trained. Input of the feature extraction model may be an amplitude component and a phase component of a subband to be extracted, and output of the feature extraction model is an amplitude feature of the amplitude component and a phase feature of the phase component of the subband. In this way, the corresponding amplitude feature and phase feature may be obtained by inputting the amplitude component and the phase component of the subband into the trained feature extraction model. The feature extraction model may be any type of model capable of extracting the amplitude feature and/or phase feature, such as a neural network model.

At block 204, an amplitude suppression factor of the at least one subband is determined based on the amplitude feature of the at least one subband, and a phase correction factor of the at least one subband is determined based on the phase feature of the at least one subband.

In the embodiment of the present disclosure, the amplitude suppression factor of the at least one subband is determined based on the amplitude feature of the at least one subband, and the phase correction factor of the at least one subband is determined based on the phase feature of the at least one subband.

At block 205, the noise-reduced speech is obtained by performing an amplitude suppression process, with the amplitude suppression factor of the at least one subband, on the corresponding subband in the source speech, and performing a phase correction process, with the phase correction factor of the at least one subband, on the corresponding subband in the source speech.

In the embodiment of the present disclosure, the amplitude suppression process is performed, by using the amplitude suppression factor of the at least one subband, on the corresponding subband in the source speech, and the phase correction process is performed, by using the phase correction factor of the at least one subband, on the corresponding subband in the source speech, and thus the noise-reduced speech is obtained.

Thus, by obtaining the amplitude feature and the phase feature of the at least one subband of the source speech, an amount of feature information obtainable in the source speech is increased. Further, the corresponding amplitude suppression factor is determined based on the amplitude feature and the corresponding phase correction factor is determined based on the phase feature, and thus additional channel for noise suppression is increased, thereby achieving the removal of background noise and reverberant noise from the source speech, and improving the noise reduction effect for the speech.

At block 206, a speech recognition process is performed on the noise-reduced speech to obtain corresponding text information.

At block 207, the text information of the noise-reduced speech and a preset tag are input into a trained acoustic model to obtain a predicted acoustic feature matching the text information.

At block 208, a target speech is generated based on the predicted acoustic feature.

It is to be noted that the specific implementation processes and principles of blocks 206-208 can be described with reference to blocks 103-105 of the above embodiments and will not be repeated here.

According to the method for synthetizing a speech of the present disclosure, the subband decomposition process is performed on the source speech to obtain the at least one subband. The amplitude component feature of the at least one subband is extracted to obtain the amplitude feature, and the phase component feature of the at least one subband is extracted to obtain the phase feature. The amplitude suppression factor of the at least one subband is determined based on the amplitude feature of the at least one subband, and the phase correction factor of the at least one subband is determined based on the phase feature of the at least one subband. The noise-reduced speech is obtained by performing the amplitude suppression process, with the amplitude suppression factor of the at least one subband, on the corresponding subband in the source speech, and performing the phase correction process, with the phase correction factor of the at least one subband, on the corresponding subband in the source speech. Therefore, by performing the subband decomposition process on the source speech, extracting the amplitude feature and phase feature of the subband(s), and determining the corresponding amplitude suppression factor and phase correction factor, the amplitude suppression process and phase correction process for the source speech can be realized according to the amplitude suppression factor and phase correction factor of the subband(s), thereby achieving the suppression effect on the noise in the source speech, and reducing the interference of ambient noise and improving the effect of speech synthesis.

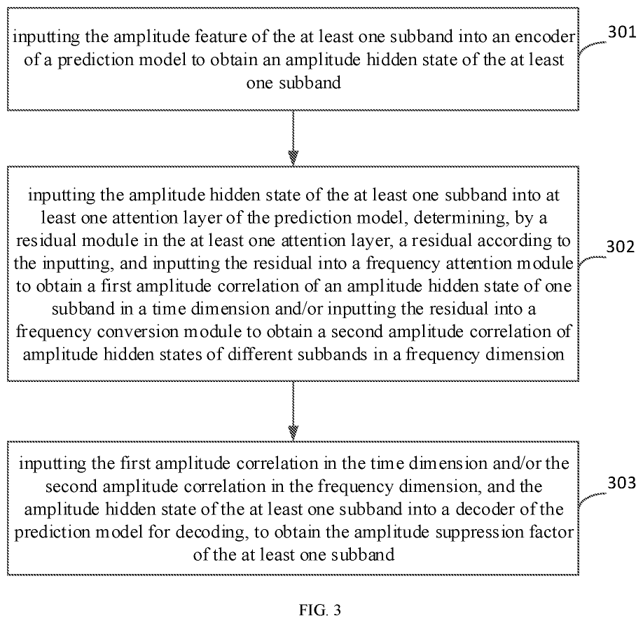

To clearly illustrate the process of determining the amplitude suppression factor of the at least one subband based on the amplitude feature of the at least one subband at block 204 in the embodiments shown in FIG. 2, a process of determining the amplitude suppression factor of the at least one subband is provided in the embodiments and illustrated in FIG. 3. As shown in FIG. 3, determining the amplitude suppression factor of the at least one subband based on the amplitude feature of the at least one subband includes the following operations.

At block 301, the amplitude feature of the at least one subband is input into an encoder of a prediction model, to obtain an amplitude hidden state of the subband.

In the embodiment of the present disclosure, the amplitude feature of the at least one subband is input to the encoder in the trained prediction model, to obtain the corresponding amplitude hidden state of the subband. The prediction model may be pre-trained, and the prediction model may be a neural network model.

At block 302, the amplitude hidden state of the at least one subband is input into at least one attention layer of the prediction model, a residual is determined by a residual module in the at least one attention layer according to the input of amplitude hidden state of the at least one subband, and the residual is input into a frequency attention module to obtain a first amplitude correlation of an amplitude hidden state of one subband in a time dimension and/or the residual is input into a frequency conversion module to obtain a second amplitude correlation of amplitude hidden states of different subbands in a frequency dimension.

In the embodiment of the present disclosure, the amplitude hidden state of the at least one subband is input into the at least one attention layer of the prediction model, the residual module in the attention layer is used to determine the corresponding residual for the amplitude hidden state of the at least one subband, and the residual is input into the frequency attention module to obtain the first amplitude correlation of the amplitude hidden state of one subband (any subband selected from the at least one subband) in the time dimension, and/or the residual is input into the frequency conversion module to obtain the second amplitude correlation of the amplitude hidden states of different subbands (selected from the at least one subband in the case the at least one subband consists of two or more subbands) in the frequency dimension. That is, the residual is input into the frequency attention module to obtain the first amplitude correlation of the amplitude hidden state of the same subband in the time dimension, or the residual is input into the frequency conversion module to obtain the second amplitude correlation of the amplitude hidden states of different subbands in the frequency dimension, or the residual is input into the frequency attention module to obtain the first amplitude correlation of the amplitude hidden state of the same subband in the time dimension and the residual is input into the frequency conversion module to obtain the second amplitude correlation of the amplitude hidden states of different subbands in the frequency dimension.

It is noted that the first amplitude correlation of the amplitude hidden state of one subband in the time dimension refers to an amplitude relation between the amplitude hidden state of the one subband and the time. In other words, the first amplitude correlation may indicate that the amplitude hidden state of the same subband varies at different consecutive times. The second amplitude correlation of the amplitude hidden states of different subbands in the frequency dimension refers to an amplitude relation between the amplitude hidden states of different subbands at the same frequency amplitude. In other word, at the same frequency amplitude, different subbands may have different amplitude hidden states.

At block 303, the first amplitude correlation in the time dimension and/or the second amplitude correlation in the frequency dimension, and the amplitude hidden state of the at least one subband are input into a decoder of the prediction model for decoding, to obtain the amplitude suppression factor of the at least one subband.

In the embodiment of the present disclosure, the first amplitude correlation in the time dimension and/or the second amplitude correlation in the frequency dimension obtained at block 302 and the amplitude hidden state of the at least one subband obtained at block 301 are input into the decoder of the prediction model for decoding, to obtain the amplitude suppression factor for the at least one subband.

The amplitude feature of the at least one subband is input into the encoder of the prediction model to obtain the amplitude hidden state of the at least one subband. The amplitude hidden state of the at least one subband is input into the at least one attention layer of the prediction model, the residual of the input is determined by the residual module in the at least one attention layer. The residual is input into the frequency attention module to obtain the first amplitude hidden state of one subband in the time dimension, and/or the residual is input into the frequency conversion module to obtain the second amplitude correlation of the amplitude hidden states of different subbands in the frequency dimension. The first amplitude correlation in the time dimension and/or the second amplitude correlation in the frequency dimension and the amplitude hidden state of the at least one subband are input to the decoder of the prediction model for decoding to obtain the amplitude suppression factor of the at least one subband. Thus, the amplitude feature of the at least one subband corresponding to the source speech is obtained, the amount of feature information that can be obtained from the source speech is increased, and the corresponding amplitude suppression factor is determined according to the amplitude feature, thereby increasing the number of channels for noise suppression, achieving the removal of the background noise and the reverberant noise from the source speech, and improving the noise reduction effect of the speech.

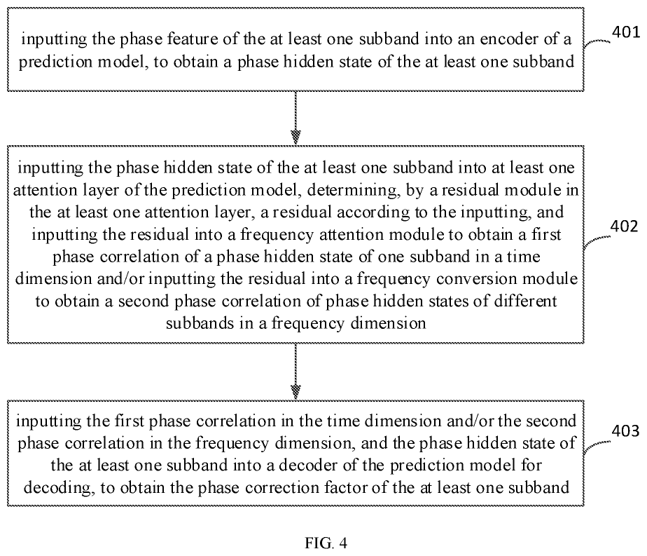

To clearly illustrate the process of determining the phase correction factor of the at least one subband based on the phase feature of the at least one subband at block 204 in the embodiments shown in FIG. 2, the process of determining the phase correction factor for the at least one subband is provided in the embodiments and illustrated in FIG. 4. As shown in FIG. 4, determining the phase correction factor of the at least one subband based on the phase feature of the at least one subband may include the following operations.

At block 401, the phase feature of the at least one subband is input into an encoder of a prediction model to obtain a phase hidden state of the at least one subband.

In the embodiment of the present disclosure, the phase feature of the at least one subband may be input to the encoder in the trained prediction model to obtain the corresponding phase hidden state of the at least one subband. The prediction model may be pre-trained, and the prediction model may be a neural network model.

At block 402, the phase hidden state of the at least one subband is input into at least one attention layer of the prediction model, a residual is determined by a residual module in the at least one attention layer according to the input of the phase hidden state of the at least one subband, and the residual is input into a frequency attention module to obtain a first phase correlation of a phase hidden state of one subband in a time dimension and/or the residual is input into a frequency conversion module to obtain a second phase correlation of phase hidden states of different subbands in a frequency dimension.

In the embodiment of the present disclosure, the phase hidden state of the at least one subband is input into the at least one attention layer of the prediction model, the residual module in the at least one attention layer is used to determine the corresponding residual of the phase hidden state of the at least one subband. The residual is input into the frequency attention module to obtain the first phase correlation of the phase hidden state of one subband (i.e., any subband selected from the at least one subband) in the time dimension and/or the residual is input into the frequency conversion module to obtain the second phase correlation of the phase hidden states of different subbands (selected from the at least one subband in the case the at least one subband consists of two or more subbands) in the frequency dimension. That is, the residual is input into the frequency attention module to obtain the first phase correlation of the phase hidden state of the same subband in the time dimension, or the residual is input into the frequency conversion module to obtain the second phase correlation of the phase hidden states of different subbands in the frequency dimension, or the residual is input into the frequency attention module to obtain the first phase correlation of the phase hidden state of the same subband in the time dimension and the residual is input into the frequency conversion module to obtain the second phase correlation of the phase hidden states of different subbands in the frequency dimension.

It is noted that the first phase correlation of the phase hidden state of the one subband in the time dimension refers to a phase relation between the phase hidden state of the subband and the time. In other words, the first phase correlation may indicate that the phase hidden state of the subband varies at different consecutive times. The second phase correlation of the phase hidden states of different subbands in the frequency dimension refers to a phase relation between the phase hidden states of different subbands at the same frequency amplitude. In other words, at the same frequency amplitude, different subbands may have different amplitude hidden states.

At block 403, the first phase correlation in the time dimension and/or the second phase correlation in the frequency dimension, and the phase hidden state of the subband are input into a decoder of the prediction model for decoding, to obtain the phase correction factor of the at least one subband.

In the embodiment of the present disclosure, the first phase correlation in the time dimension and/or the second phase correlation in the frequency dimension obtained at block 402 and the phase hidden state of the at least one subband obtained at block 401 are input into the decoder of the prediction model for decoding, to obtain the phase correction factor for the at least one subband.

The phase feature of the at least one subband is input into the encoder of the prediction model to obtain the phase hidden state of the at least one subband. The phase hidden state of the at least one subband is input into the at least one attention layer of the prediction model to determine the residual of the input by using the residual module in the at least one attention layer. The residual is input into the frequency attention module to obtain the first phase correlation of the phase hidden state of one subband in the time dimension, and/or the residual is input into the frequency conversion module to obtain the second phase correlation of the phase hidden states of different subbands in the frequency dimension. The first phase correlation in the time dimension and/or the second phase correlation in the frequency dimension and the phase hidden state of the at least one subband are input to the decoder of the prediction model for decoding to obtain the phase correction factor for the at least one subband. Thus, the phase feature of the at least one subband corresponding to the source speech is obtained, the amount of feature information obtainable in the source speech is increased, and the corresponding phase correction factor is determined according to the phase feature, thereby increasing the channels for noise suppression, achieving the removal of the background noise and the reverberant noise from the source speech, and improving the noise reduction effect of the speech.

The above noise reduction process is further described in combination with a structural diagram of the model.

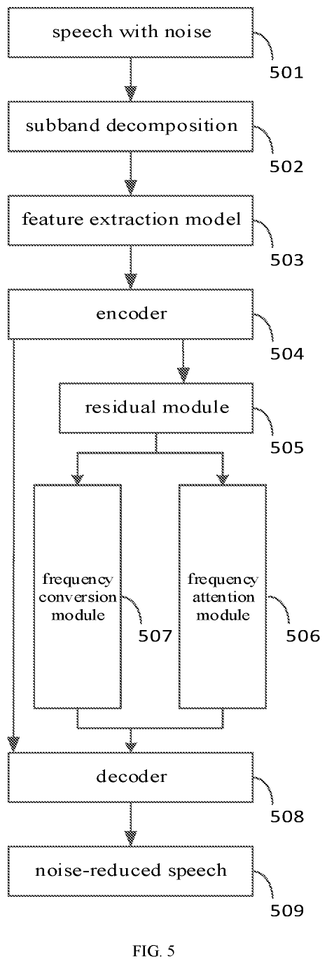

FIG. 5 is a block diagram of the noise reduction process in a scene. As shown in FIG. 5, a speech 501 with noise(s) is subjected to the subband decomposition process 502 to obtain at least one subband. The feature extraction model 503 is configured to extract the amplitude component feature of the at least one subband to obtain the amplitude feature, and extract the phase component feature of the at least one subband to obtain the phase feature. The amplitude feature of the at least one subband is input into the encoder 504 of the prediction model to obtain the amplitude hidden state of the at least one subband, and the phase feature of the at least one subband is input into the encoder 504 of the prediction model to obtain the phase hidden state of the at least one subband. The amplitude hidden state of the at least one subband is input to the at least one attention layer of the prediction model, the residual corresponding to the amplitude hidden state of the at least one subband is determined by the residual module 505 in the attention layer. The residual is input into the frequency attention module 506 to obtain the first amplitude correlation of the amplitude hidden state of one subband in the time dimension, and/or the residual is input into the frequency conversion module 507 to obtain the second amplitude correlation of the amplitude hidden states of different subbands in the frequency dimension. The phase hidden state of the at least one subband is input into the at least one attention layer of the prediction model to determine the residual corresponding to the phase hidden state of the at least one subband by using the residual module 505 in the attention layer. The residual is input into the frequency attention module 506 to obtain the first phase correlation of the phase hidden state of one subband in the time dimension, and/or the residual is input into the frequency conversion module 507 to obtain the second phase correlation of the phase hidden states of different subbands in the frequency dimension. The first amplitude correlation in the time dimension and/or the second amplitude correlation in the frequency dimension and the amplitude hidden state of the at least one subband are input the decoder 508 of the prediction model for decoding to obtain the amplitude suppression factor of the at least one subband. The first phase correlation in the time dimension and/or the second phase correlation in the frequency dimension and the phase hidden state of the at least one subband are input into the decoder 508 of the prediction model for decoding to obtain the phase correction factor of the at least one subband. The amplitude suppression is performed, with the amplitude suppression factor of the at least one subband, on the corresponding subband in the speech with the noise(s), and the phase correction is performed, with the phase correction factor of the at least one subband, on the corresponding subband in the speech with the noise(s), thereby obtaining the noise-reduced speech 509.

The amplitude feature of the at least one subband and the phase feature of the at least one subband are obtained via the subband decomposition and the feature extraction on the speech with the noise, thus the amplitude suppression factor of the at least one subband is determined based on the amplitude feature of the at least one subband, and the phase correction factor of the at least one subband is determined based on the phase feature of the at least one subband. Furthermore, the amplitude suppression process is performed, with the amplitude suppression factor of the at least one subband, on the at least one subband of the speech with the noise, and the phase correction process is performed, with the phase correction factor of the at least one subband, on the subband in the speech with the noise, thereby obtaining the noise-reduced speech. Therefore, the amplitude suppression and the phase correction are performed on the speech with the noise based on the amplitude suppression factor and phase correction factor of the subband, the noise in the speech is suppressed and the interference of the environmental noise is reduced.

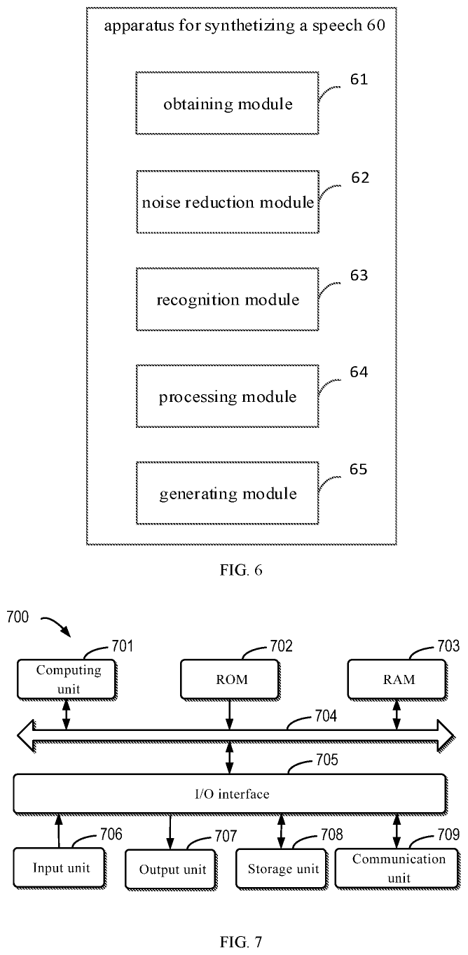

The apparatus for synthetizing a speech of the present disclosure is described below with reference to FIG. 6.

FIG. 6 is a block diagram of an apparatus for synthetizing a speech of the present disclosure.

As illustrated in FIG. 6, the apparatus for synthetizing a speech 60 includes: an obtaining module 61, a noise reduction module 62, a recognition module 63, a processing module 64 and a generating module 65. The obtaining module 61 is configured to obtain a source speech. The noise reduction module 62 is configured to suppress a noise in the source speech based on an amplitude component and/or a phase component of the source speech to obtain a noise-reduced speech. The recognition module 63 is configured to perform a speech recognition process on the noise-reduced speech to obtain corresponding text information. The processing module 64 is configured to input the text information of the noise-reduced speech and a preset tag into a trained acoustic model to obtain a predicted acoustic feature matching the text information. The generating module 65 is configured to generate a target speech based on the predicted acoustic feature.

In an embodiment, the noise reduction module 62 includes: a decomposition unit 621, an extracting unit 622, a determining unit 623 and a first processing unit 624. The decomposition unit 621 is configured to perform a subband decomposition process on the source speech, to obtain at least one subband. The extracting unit 622 is configured to extract an amplitude component feature of the at least one subband to obtain an amplitude feature, and extract a phase component feature of the at least one subband to obtain a phase feature. The determining unit 623 is configured to determine an amplitude suppression factor of the at least one subband based on the amplitude feature of the at least one subband, and determine a phase correction factor of the at least one subband based on the phase feature of the at least one subband. The first processing unit 624 is configured to obtain the noise-reduced speech by performing an amplitude suppression process, with the amplitude suppression factor of the at least one subband, on the at least one subband in the source speech, and performing a phase correction process, with the phase correction factor of the at least one subband, on the at least one subband in the source speech.

In an embodiment, the determining unit 623 is configured to: input the amplitude feature of the at least one subband into an encoder of a prediction model to obtain an amplitude hidden state of the at least one subband; input the amplitude hidden state of the at least one subband into at least one attention layer of the prediction model, determine, by a residual module in the at least one attention layer, a residual according to input of the amplitude hidden state of the at least one subband, and input the residual into a frequency attention module to obtain a first amplitude correlation of an amplitude hidden state of one subband in a time dimension and/or input the residual into a frequency conversion module to obtain a second amplitude correlation of amplitude hidden states of different subbands in a frequency dimension; and input the first amplitude correlation in the time dimension and/or the second amplitude correlation in the frequency dimension, and the amplitude hidden state of the at least one subband into a decoder of the prediction model for decoding, to obtain the amplitude suppression factor of the at least one subband.

In an example embodiment, the determining unit 623 is configured to: input the phase feature of the at least one subband into an encoder of a prediction model to obtain a phase hidden state of the at least one subband; input the phase hidden state of the at least one subband into at least one attention layer of the prediction model to determine, by a residual module in the at least one attention layer, a residual according to input of the phase hidden state of the at least one subband, and input the residual into a frequency attention module to obtain a first phase correlation among phase hidden states of the same subband in a time dimension and/or input the residual into a frequency conversion module to obtain a second phase correlation among phase hidden states of different subbands in a frequency dimension; and input the first phase correlation in the time dimension and/or the second phase correlation in the frequency dimension, and the phase hidden state of the at least one subband into a decoder of the prediction model for decoding, to obtain the phase correction factor of the at least one subband.

In an embodiment, the recognition module 63 includes: a recognition unit 631 and a second processing unit 632. The recognition unit 631 is configured to perform the speech recognition process on the noise-reduced speech to obtain a PPG feature, in which the PPG feature represents a probability that at least one acoustic segment in the noise-reduced speech belongs to a preset linguistic unit. The second processing unit 632 is configured to determine the PPG feature as the text information of the noise-reduced speech.

With the apparatus for synthetizing a speech of the embodiments of the present disclosure, the source speech is obtained, the noise in the source speech is suppressed according to the amplitude component and/or the phase component of the source speech, to obtain the noise-reduced speech. After performing the speech recognition process on the noise-reduced speech to obtain the corresponding text information, the text information of the noise-reduced speech and the preset tag are input into the trained acoustic model to obtain the predicted acoustic feature matching the text information. The target speech is generated according to the predicted acoustic feature. Therefore, the noise reduction process is performed on the source speech based on the amplitude component and/or the phase component of the source speech, to reduce the noise interference and improve the effect of the speech synthesis.

According to the embodiments of the present disclosure, the present disclosure further provides an electronic device, a computer-readable storage medium and a computer program product.

FIG. 7 is a block diagram of an electronic device 700 according to the embodiments of the present disclosure. The electronic device may refer to various forms of digital computers, such as laptop computers, desktop computers, workbenches, personal digital assistants, servers, blade servers, mainframe computers, and other suitable computers. The electronic device may also refer to various forms of mobile devices, such as personal digital processing, cellular phones, smart phones, wearable devices, and other similar computing devices. The components shown here, their connections and relations, and their functions are merely examples, and are not intended to limit the implementation of the present disclosure described and/or required herein.

As illustrated in FIG. 7, the device 700 includes a computing unit 701 performing various appropriate actions and processes based on computer programs stored in a read-only memory (ROM) 702 or computer programs loaded from the storage unit 708 to a random access memory (RAM) 703. In the RAM 703, various programs and data required for the operation of the device 700 are stored. The computing unit 701, the ROM 702, and the RAM 703 are connected to each other through a bus 704. An input/output (I/O) interface 705 is also connected to the bus 704.

Components in the device 700 are connected to the I/O interface 705, including: an inputting unit 706, such as a keyboard, a mouse; an outputting unit 707, such as various types of displays, speakers; a storage unit 708, such as a disk, an optical disk; and a communication unit 709, such as network cards, modems, wireless communication transceivers, and the like. The communication unit 709 allows the device 700 to exchange information/data with other devices through a computer network such as the Internet and/or various telecommunication networks.

The computing unit 701 may be various general-purpose and/or dedicated processing components with processing and computing capabilities. Some examples of computing unit 701 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 701 executes the various methods and processes described above, such as the method for synthetizing a speech. For example, in some embodiments, the method may be implemented as a computer software program, which is tangibly contained in a machine-readable medium, such as the storage unit 708. In some embodiments, part or all of the computer program may be loaded and/or installed on the device 700 via the ROM 702 and/or the communication unit 709. When the computer program is loaded on the RAM 703 and executed by the computing unit 701, one or more steps of the method described above may be executed. Alternatively, in other embodiments, the computing unit 701 may be configured to perform the method for synthetizing a speech in any other suitable manner (for example, by means of firmware).

Various implementations of the systems and techniques described above may be implemented by a digital electronic circuit system, an integrated circuit system, field programmable gate arrays (FPGAs), application specific integrated circuits (ASICs), application specific standard products (ASSPs), system on chip (SOCs), complex programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the present disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAM, ROM, Erasable Programmable Read-Only Memories (EPROM or flash memory), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server can be a cloud server, also known as a cloud computing server or a cloud host, which is a host product in the cloud computing service system, to solve the traditional physical host with a virtual private server (VPS) service, which has the defects of difficult management and weak business expansibility. The server can al so be a server for a distributed system, or a server that incorporates a block-chain.

AI is a subject that causes computers to simulate certain thinking processes and intelligent behaviors (such as learning, reasoning, thinking and planning) of human beings, which covers both hardware-level technologies and software-level technologies. The AI hardware technologies generally include technologies such as sensor, special AI chip, cloud computing, distributed storage, and big data processing. The AI software technologies generally include several major aspects such as computer vision technology, speech recognition technology, natural language processing technology, machine learning/deep learning, big data processing technology and knowledge graph technology.

It should be understood that the various forms of processes shown above can be used to reorder, add or delete steps. For example, the steps described in the present disclosure could be performed in parallel, sequentially, or in a different order, as long a s the desired result of the technical solution disclosed in the present disclosure is achieved.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for synthetizing a speech, comprising:
obtaining a source speech;
suppressing a noise in the source speech based on an amplitude component and/or a phase component of the source speech to obtain a noise-reduced speech;
performing a speech recognition process on the noise-reduced speech to obtain corresponding text information;
inputting the text information of the noise-reduced speech and a preset tag into a trained acoustic model to obtain a predicted acoustic feature matching the text information; and
generating a target speech based on the predicted acoustic feature.

2. The method of claim 1, wherein the suppressing the noise in the source speech based on the amplitude component and/or the phase component of the source speech to obtain the noise-reduced speech comprises:
performing a subband decomposition process on the source speech to obtain at least one subband;
extracting an amplitude component feature of the at least one subband to obtain an amplitude feature, and extracting a phase component feature of the at least one subband to obtain a phase feature;
determining an amplitude suppression factor of the at least one subband based on the amplitude feature of the at least one subband, and determining a phase correction factor of the at least one subband based on the phase feature of the at least one subband; and
obtaining the noise-reduced speech by performing an amplitude suppression process, with the amplitude suppression factor of the at least one subband, on the at least one subband in the source speech, and performing a phase correction process, with the phase correction factor of the at least one subband, on the at least one subband in the source speech.

3. The method of claim 2, wherein the determining the amplitude suppression factor of the at least one subband based on the amplitude feature of the at least one subband comprises:
inputting the amplitude feature of the at least one subband into an encoder of a prediction model to obtain an amplitude hidden state of the at least one subband;
inputting the amplitude hidden state of the at least one subband into at least one attention layer of the prediction model, determining, by a residual module in the at least one attention layer, a residual according to the inputting, and inputting the residual into a frequency attention module to obtain a first amplitude correlation of an amplitude hidden state of one subband in a time dimension and/or inputting the residual into a frequency conversion module to obtain a second amplitude correlation of amplitude hidden states of different subbands in a frequency dimension; and
inputting the first amplitude correlation in the time dimension and/or the second amplitude correlation in the frequency dimension, and the amplitude hidden state of the at least one subband into a decoder of the prediction model for decoding, to obtain the amplitude suppression factor of the at least one subband.

4. The method of claim 2, wherein the determining the phase correction factor of the at least one subband based on the phase feature of the at least one subband comprises:
inputting the phase feature of the at least one subband into an encoder of a prediction model, to obtain a phase hidden state of the at least one subband;
inputting the phase hidden state of the at least one subband into at least one attention layer of the prediction model, determining, by a residual module in the at least one attention layer, a residual according to the inputting, and inputting the residual into a frequency attention module to obtain a first phase correlation of a phase hidden state of one subband in a time dimension and/or inputting the residual into a frequency conversion module to obtain a second phase correlation of phase hidden states of different subbands in a frequency dimension; and
inputting the first phase correlation in the time dimension and/or the second phase correlation in the frequency dimension, and the phase hidden state of the at least one subband into a decoder of the prediction model for decoding, to obtain the phase correction factor of the at least one subband.

5. The method of claim 1, wherein the performing the speech recognition process on the noise-reduced speech to obtain the text information comprises:
performing the speech recognition process on the noise-reduced speech to obtain a phonetic posteriorgram feature, wherein the phonetic posteriorgram feature represents a probability that at least one acoustic segment in the noise-reduced speech belongs to a preset linguistic unit; and
determining the phonetic posteriorgram feature as the text information of the noise-reduced speech.

6. The method of claim 1, wherein the preset tag comprises a preset timbre feature, and the trained acoustic model is configured to convert a timbre feature of the source speech into the preset timbre feature.

7. The method of claim 1, wherein the predicted acoustic feature comprises a spectral envelope feature of a mel scale.

8. An electronic device, comprising:
at least one processor; and
a memory communicated with the at least one processor;
wherein the memory stores instructions executable by the at least one processor, and when the instructions are executed by the at least one processor, the at least one processor is configured to implement a method for synthetizing a speech, the method comprising:
obtaining a source speech;
suppressing a noise in the source speech based on an amplitude component and/or a phase component of the source speech to obtain a noise-reduced speech;
performing a speech recognition process on the noise-reduced speech to obtain corresponding text information;
inputting the text information of the noise-reduced speech and a preset tag into a trained acoustic model to obtain a predicted acoustic feature matching the text information; and
generating a target speech based on the predicted acoustic feature.

9. The electronic device of claim 8, wherein the suppressing the noise in the source speech based on the amplitude component and/or the phase component of the source speech to obtain the noise-reduced speech comprises:
performing a subband decomposition process on the source speech to obtain at least one subband;
extracting an amplitude component feature of the at least one subband to obtain an amplitude feature, and extracting a phase component feature of the at least one subband to obtain a phase feature;
determining an amplitude suppression factor of the at least one subband based on the amplitude feature of the at least one subband, and determining a phase correction factor of the at least one subband based on the phase feature of the at least one subband; and
obtaining the noise-reduced speech by performing an amplitude suppression process, with the amplitude suppression factor of the at least one subband, on the at least one subband in the source speech, and performing a phase correction process, with the phase correction factor of the at least one subband, on the at least one subband in the source speech.

10. The electronic device of claim 9, wherein the determining the amplitude suppression factor of the at least one subband based on the amplitude feature of the at least one subband comprises:
inputting the amplitude feature of the at least one subband into an encoder of a prediction model to obtain an amplitude hidden state of the at least one subband;
inputting the amplitude hidden state of the at least one subband into at least one attention layer of the prediction model, determining, by a residual module in the at least one attention layer, a residual according to the inputting, and inputting the residual into a frequency attention module to obtain a first amplitude correlation of an amplitude hidden state of one subband in a time dimension and/or inputting the residual into a frequency conversion module to obtain a second amplitude correlation of amplitude hidden states of different subbands in a frequency dimension; and
inputting the first amplitude correlation in the time dimension and/or the second amplitude correlation in the frequency dimension, and the amplitude hidden state of the at least one subband into a decoder of the prediction model for decoding, to obtain the amplitude suppression factor of the at least one subband.

11. The electronic device of claim 9, wherein the determining the phase correction factor of the at least one subband based on the phase feature of the at least one subband comprises:
inputting the phase feature of the at least one subband into an encoder of a prediction model, to obtain a phase hidden state of the at least one subband;
inputting the phase hidden state of the at least one subband into at least one attention layer of the prediction model, determining, by a residual module in the at least one attention layer, a residual according to the inputting, and inputting the residual into a frequency attention module to obtain a first phase correlation of a phase hidden state of one subband in a time dimension and/or inputting the residual into a frequency conversion module to obtain a second phase correlation of phase hidden states of different subbands in a frequency dimension; and
inputting the first phase correlation in the time dimension and/or the second phase correlation in the frequency dimension, and the phase hidden state of the at least one subband into a decoder of the prediction model for decoding, to obtain the phase correction factor of the at least one subband.

12. The electronic device of claim 8, wherein the performing the speech recognition process on the noise-reduced speech to obtain the text information comprises:
performing the speech recognition process on the noise-reduced speech to obtain a phonetic posteriorgram feature, wherein the phonetic posteriorgram feature represents a probability that at least one acoustic segment in the noise-reduced speech belongs to a preset linguistic unit; and
determining the phonetic posteriorgram feature as the text information of the noise-reduced speech.

13. The electronic device of claim 8, wherein the preset tag comprises a preset timbre feature, and the trained acoustic model is configured to convert a timbre feature of the source speech into the preset timbre feature.

14. The electronic device of claim 8, wherein the predicted acoustic feature comprises a spectral envelope feature of a mel scale.

15. A non-transitory computer-readable storage medium having stored computer instructions, wherein the computer instructions are executed to cause a computer to implement a method for synthetizing a speech, the method comprising:
obtaining a source speech;
suppressing a noise in the source speech based on an amplitude component and/or a phase component of the source speech to obtain a noise-reduced speech;
performing a speech recognition process on the noise-reduced speech to obtain corresponding text information;
inputting the text information of the noise-reduced speech and a preset tag into a trained acoustic model to obtain a predicted acoustic feature matching the text information; and
generating a target speech based on the predicted acoustic feature.

16. The non-transitory computer-readable storage medium of claim 15, wherein the suppressing the noise in the source speech based on the amplitude component and/or the phase component of the source speech to obtain the noise-reduced speech comprises:
performing a subband decomposition process on the source speech to obtain at least one subband;
extracting an amplitude component feature of the at least one subband to obtain an amplitude feature, and extracting a phase component feature of the at least one subband to obtain a phase feature;
determining an amplitude suppression factor of the at least one subband based on the amplitude feature of the at least one subband, and determining a phase correction factor of the at least one subband based on the phase feature of the at least one subband; and
obtaining the noise-reduced speech by performing an amplitude suppression process, with the amplitude suppression factor of the at least one subband, on the at least one subband in the source speech, and performing a phase correction process, with the phase correction factor of the at least one subband, on the at least one subband in the source speech.

17. The non-transitory computer-readable storage medium of claim 16, wherein the determining the amplitude suppression factor of the at least one subband based on the amplitude feature of the at least one subband comprises:
inputting the amplitude feature of the at least one subband into an encoder of a prediction model to obtain an amplitude hidden state of the at least one subband;
inputting the amplitude hidden state of the at least one subband into at least one attention layer of the prediction model, determining, by a residual module in the at least one attention layer, a residual according to the inputting, and inputting the residual into a frequency attention module to obtain a first amplitude correlation of an amplitude hidden state of one subband in a time dimension and/or inputting the residual into a frequency conversion module to obtain a second amplitude correlation of amplitude hidden states of different subbands in a frequency dimension; and
inputting the first amplitude correlation in the time dimension and/or the second amplitude correlation in the frequency dimension, and the amplitude hidden state of the at least one subband into a decoder of the prediction model for decoding, to obtain the amplitude suppression factor of the at least one subband.

18. The non-transitory computer-readable storage medium of claim 16, wherein the determining the phase correction factor of the at least one subband based on the phase feature of the at least one subband comprises:
inputting the phase feature of the at least one subband into an encoder of a prediction model, to obtain a phase hidden state of the at least one subband;
inputting the phase hidden state of the at least one subband into at least one attention layer of the prediction model, determining, by a residual module in the at least one attention layer, a residual according to the inputting, and inputting the residual into a frequency attention module to obtain a first phase correlation of a phase hidden state of one subband in a time dimension and/or inputting the residual into a frequency conversion module to obtain a second phase correlation of phase hidden states of different subbands in a frequency dimension; and
inputting the first phase correlation in the time dimension and/or the second phase correlation in the frequency dimension, and the phase hidden state of the at least one subband into a decoder of the prediction model for decoding, to obtain the phase correction factor of the at least one subband.

19. The non-transitory computer-readable storage medium of claim 15, wherein the performing the speech recognition process on the noise-reduced speech to obtain the text information comprises:
performing the speech recognition process on the noise-reduced speech to obtain a phonetic posteriorgram feature, wherein the phonetic posteriorgram feature represents a probability that at least one acoustic segment in the noise-reduced speech belongs to a preset linguistic unit; and
determining the phonetic posteriorgram feature as the text information of the noise-reduced speech.

20. The non-transitory computer-readable storage medium of claim 15, wherein the preset tag comprises a preset timbre feature, and the trained acoustic model is configured to convert a timbre feature of the source speech into the preset timbre feature.
